(19) United States
(12) Patent Application Publication
(10) Pub. No.: US 2004/0195515 A1
(43) Pub. Date: Oct. 7, 2004

(54) Laminated radiation detector and process for fabrication thereof

(76) Inventors: James M Wheeler, Naples, FL (US); Benjamin Joshua Reisman, Halamish (IL); Michael Schieber, Jerusalem (IL); Haim Hermon, Jerusalem (IL); Eliezer Shtekel, Kiryat Arba (IL); Leonid Melekhov, Kiryat Ekron (IL)

Correspondence Address: SQUIRE, SANDERS & DEMPSEY L.L.P, 600 HANSEN WAY, PALO ALTO, CA, 94304-1043, US

(21) Appl. No.: 10/481,539

(22) PCT Filed:
(86) PCT No.: PCT/IL02/00472

(30) Foreign Application Priority Data
Jun. 19, 2001 (IL) 143853

(51) Int. Cl. G01T 1/24

(52) U.S. Cl. 250/370.12

(57) ABSTRACT

A continuous multi-layer construction for detecting radiation including a polymer layer, a conducting electrode layer affixed to the polymer layer and a particle-in-binder composite layer affixed to the conducting electrode layer, where the composite layer absorbs photons. A process for fabricating continuous multi-layer constructions for detection of radiation including the following steps: depositing a conducting electrode layer onto a polymer film, applying at least one coating layer of a particle-in-binder composite onto the conducting electrode layer, and drying the at least one coating layer of the particle-in-binder composite.

### FIELD OF THE INVENTION

The present invention relates to large area multi-layer polymer based high energy electromagnetic radiation detecting and imaging devices, systems containing such devices, and processes for the fabrication thereof.

### BACKGROUND OF THE INVENTION

X-ray and gamma ray detection are useful in a wide variety of scientific and technical endeavors. These include medical imaging applications such as X-ray radiography, X-ray computed tomography (CT), single photon emission computed tomography (SPECT) and positron emission tomography (PET). Also of note are non-destructive testing and quality control of manufacturing components, baggage inspection systems, such as those installed at customs, and astrophysics and astronomy applications, such as galactic surveys and space exploration.

Special photographic plates can be used for X-ray detection. For repeated use however, and for maximum data collection, semiconductor detectors exhibiting the well known photo-electric effect, whereby incident photons of radiation generate charge carriers, offer many advantages, not least of which, is that the electronic signals generated can be readily processed to produce numerical data for digital image processing and the like.

Mercuric iodide (HgI2), cadmium telluride (CdTe), cadmium zinc telluride (CdZnTe) and lead iodide (PbI2), having wide band gaps of 2.2 eV, 1.45 eV, 1.5 eV and 2.6 eV respectively, are well known room temperature X-ray detectors. Electrodes are applied to both sides of the wide band gap semiconducting substance, and a potential difference is maintained between the electrodes. Bombardment by high-energy photons, such as X-rays and gamma rays, results in the formation of hole-electron pairs, which causes current to flow between the electrodes. This electrical signal is used for detection purposes, its intensity being related to the intensity of radiation incident on the wide band gap semiconducting substance.

By high-energy radiation, radiation in the range of from about 6 KeV to several MeV is intended. For most X-ray detecting applications, detection of radiation in the range of from about 15 KeV to about 500 KeV is used.

For mapping purposes, such as medical diagnostic applications, large detectors are preferred. One or both electrodes may be divided into a pixel array, each pixel detecting radiation in its vicinity.

To provide uniform properties across the surface of the wide band gap semiconducting substance, plates cut and polished from single crystals have traditionally been used. These are, however, expensive and time consuming to grow, and only limited sizes have been achieved.

Mercuric iodide (HgI₂) and lead iodide (PbI₂) have significantly higher atomic weights and thus X-ray stopping power than cadmium telluride (CdTe), and cadmium zinc telluride (CdZnTe). Since the dominant charge carriers in HgI₂ are electrons and not holes, as is the case with PbI₂, it is possible to construct detectors comprising thicker layers of HgI₂ than of PbI₂. For the aforementioned reasons, HgI₂ is the preferred material for use in X-ray detectors and X-ray imagers.

To overcome the inherent size limitations of single crystals and their high costs, the use of polycrystalline, coherent, continuous films have been disclosed in U.S. Pat. No. 5,892,227, incorporated herein by reference. U.S. Pat. No. 5,892,227 describes methods for producing such plates from wide band semiconductors by various techniques including hot pressing and sintering of ultra-fine powder, mixing the powdered material with a binder to form a composite material for subsequent painting onto an appropriate substrate, and by sublimation and subsequent condensation on a cooled substrate. The latter is essentially a PVD technology.

A review of polycrystalline HgI₂ detectors and imagers is to be found in the following publications:

R. Turchetta, et al., VLSI Readout for Imaging with Polycrystalline Mercuric Iodide Detectors, Proceedings of the SPIE Conf., San Diego, Calif., July 1998, edited by O. H. W. Siegmunds and M. A. Gummin, Vol. 3445 (1998), p.p. 356-363.

R. Turchetta, et al., Imaging with Polycrystalline Mercuric Iodide Detectors using VLSI Readout, Proceedings of the Detector Workshop held at XIIth Int. Conf Cryst. Growth, Jerusalem, Israel, July 1998, edited by R. B. James, L. Franks, P., Nucl. Inst. and Meth. A, Vol. 428 (1999), p.p. 88.

M. Schieber, et al., High Flux X-ray Response of Composite Mercuric Iodide Detectors, Hard Radiation SPIE, Denver, 1999, Vol. 3768 (1999), p.p. 296-309.

M. Schieber, et al., Polycrystalline Mercuric Iodide Detectors, Medical Imaging Proc., SPIE, Denver, 1999, Vol. 3770 (1999), p.p. 146-155.

R. Street, et al., High Resolution. Direct Detection X-Ray Imagers, Proceedings of SPIE, Vol. 3977 (2000), p. 418.

M. Schieber, et al., Radiological X-ray Response of Polycrystalline Mercuric Iodide Detectors, Proceedings of the SPIE Medical Imaging Conf., San Diego, 2000, Vol. 3977 (2000), p. 48.

M. Schieber et al., Mercuric Iodide Thick Films for Radiological X-ray Detectors, Proceedings of the SPIE in Penetrating Radiation, Vol. 4142 (2000), p. 197.

M. Schieber et al., Thick Films of X-ray Polycrystalline Mercuric Iodide Detectors published in JCG (8-2000).

For imaging purposes, as opposed to simply detecting high-energy radiation, the wide band gap semiconducting material used for detecting high-energy radiation is preferably deposited onto a pixel array. Pixel arrays are commercially available in a number of forms such as pixel readout flat panel (FP) thin film transistor (TFT) array, charge coupled devices (CCD) and complementary metal oxide semiconductor (CMOS) arrays. Such pixel arrays come already printed onto suitable substrates. FP or CCD substrates used for detectors comprise square pixels that are typically about 100×100 microns, each pixel being separated from its nearest neighbors in all directions by about 10-15 microns. The pixel array coated substrate serves as a substrate for fabrication of the detector plate thereon, by deposition or adhesion of the high-energy detecting wide band gap semiconductor, with the pixel array serving as the bottom electrode of the detector.

Despite the above mentioned and other advantages of HgI₂ for high energy radiation detectors and imagers, HgI₂ has the disadvantage that the material is corrosive, and is not compatible with aluminum and copper bus lines and the like, often used for TFT electronics in preferred substrates. This problem is exacerbated by the traditional wet manufacturing processes used, whereby adhesives comprising large quantities of organic solvents are used for adhering detectors, cut from single crystal wafers, to the substrate. Alternatively, detectors are grown directly on the substrates using, for example, PVD processes.

A further disadvantage of the current state of the art is that coatings are applied to commercially acquired and rather expensive pixilated substrates. Quality control is performed after the wide band gap semiconductor detecting substances are applied thereto. If the coated substrates prove unacceptable, there is little choice but to discard the coated substrate, as cleaning off the coating, leaving a useable substrate is usually impractical.

In addition, there is an inherent difficulty in the application of liquid coatings to pixilated glass substrates in that currently available pixilated glass substrates have raised pixels and a topography that varies by anything from 1-7 microns from pixel to pixel. The thickness non-uniformity of the glass substrate translates directly into coating thickness non-uniformity. This poor tolerance adversely affects the desired thickness uniformity of the dried layer.

When using a liquid coating applicator, such as a die-hopper (also known as a slot die coater), roller, bar, blade or rod, the gap between the coating applicator and the substrate critically affects the coating thickness uniformity. Currently available pixilated substrates are fabricated from glasses and ceramics, and these stiff substrates cannot be flexed to position them precisely with respect to the applicator.

It is inherently undesirable to deposit coating layers on pixilated substrates through coating and drying operations, since such handling operations subject the pixilated substrates to temperature, chemical and physical stresses, and since pixilated substrates, the most expensive elements of the detector, can be easily damaged.

### SUMMARY OF TH INVENTION

It is an object of the present invention to enable the continuous fabrication of composite films comprising particles of wide band gap semiconductors in organic binders.

It is a further object of the present invention to provide a means for retrofitting wide band gap detecting layers to pixilated substrates.

It is a further object of the present invention embodiments to provide a means of producing coating layers to higher tolerances.

It is a further object of the present invention to eliminate the requirement of applying coatings to stiff substrates in the fabrication of multi-layered detectors attached to pixilated arrays.

It is a further object of the present invention to eliminate the undesirable requirement of passing expensive and pixilated substrates through coating and drying operations in the manufacturing of multi-layered coating structures.

It is a further object of the present invention to provide a protective polymeric layer over the continuous electrode of multi-layered detectors and imagers thereby enhancing product robustness.

These and other objects of the present invention will be clear from the following description of the invention and its various embodiments.

According to a first aspect of the present invention there is thus provided a continuous multi-layer construction for detecting radiation comprising a polymer substrate, a conducting electrode layer affixed to the polymer substrate and a particle-in-binder composite layer affixed to the conducting electrode layer. The particle-in-binder composite layer absorbs photons resulting in the ejection of electrons which can be used to detect radiation.

The polymer substrate optionally comprises a polymer selected from the group of aliphatic and aromatic homopolymers and copolymers, and the particle-in-binder composite layer comprises wide band gap semiconductor particles embedded in a polymer binder. Optionally, the particle-in-binder composite layer of the continuous multi-layer construction comprises particles selected from the group comprising lead iodide (PbI₂), bismuth iodide (BiI₃), thallium bromide (TlBr), mercuric iodide (HgI₂), cadmium telluride (CdTe), cadmium zinc telluride (CdZnTe) and mixtures thereof. Optionally, the polymer binder comprises at least one polymer selected from the group comprising aliphatic and aromatic homopolymers and copolymers. Preferably, the wide band gap semiconductor particles have sizes ranging up to about 100 microns. Preferably, the particles have sizes 90% of which range up to about about 15 microns or 90% of which range up to about about 10 microns. More preferably, 90% of the particles have particle sizes of about 1 to about 5 microns.

Preferably, the ratio of semiconductor particles to polymer binder in the particle-in-binder composite layer is less than 70:30 by volume.

Optionally, the continuous multi-layer construction further comprises a conducting adhesive layer positioned between the conducting electrode layer and the particle-in-binder composite layer, for adherence of the particle-in-binder composite layer to the conducting electrode layer.

Optionally, the continuous multi-layer construction further comprises an adhesive layer in adhesive contact with an exposed surface of the particle-in-binder composite layer for adherence of the continuous multi-layer construction to a second substrate. Typically, this surface is the surface of the particle-in-binder composite layer that is distal from the conducting electrode layer. Preferably, the adhesive layer is a pressure sensitive adhesive layer, and the second substrate is a pixilated substrate.

Typically, the polymer substrate is a web-like or sheet-like substrate.

According to a second aspect of the present invention, there is provided a process for fabricating continuous multi-layer constructions for detection of radiation comprising the steps of: depositing a conducting electrode layer onto a continuous polymer film; applying at least one coating layer of a particle-in-binder composite dispersion onto the conducting electrode layer; and drying the at least one coating layer of the particle-in-binder composite dispersion.

Typically the particle-in binder composite layer is applied with a liquid film coater.

Optionally, the process for fabricating continuous multi-layer constructions for detection of radiation further comprises the steps of applying a first adhesive layer, and, drying the adhesive layer prior to applying at least one coating layer of particle-in-binder composite dispersion. Preferably, the first adhesive layer is a conductive adhesive layer. Optionally, the process further comprises the step of applying a second adhesive layer to an exposed surface of the particle-in-binder composite coating layer. Optionally, the second adhesive layer is preferably a pressure sensitive adhesive layer.

In yet another aspect of the present invention, there is provided a high-energy detection and imaging system comprising at least one element constructed from at least part of a continuous multilayer construction wherein the construction includes a polymer substrate, a conducting electrode layer affixed to the polymer substrate and a particle-in-binder composite layer affixed to the conducting electrode layer. The at least one element is then affixed to a second substrate. The particle-in-binder composite layer absorbs photons resulting in the ejection of electrons with which to detect radiation.

Optionally, the polymer substrate of the high-energy detection and imaging system comprises a polymer selected from the group of aliphatic and aromatic homopolymers and copolymers. Optionally, the particle-in-binder composite layer comprises wide band gap semiconductor particles embedded in a polymer binder. Optionally, the wide band gap semiconductor particles comprise particles selected from the following group comprising lead iodide (PbI2), bismuth iodide (BiI3), thallium bromide (TlBr), mercuric iodide (HgI2), cadmium telluride (CdTe), cadmium zinc telluride (CdZnTe) and mixtures thereof. Optionally, the polymer binder comprises at least one polymer selected from the group comprising aliphatic and aromatic homopolymers and copolymers. Preferably, the wide band gap semiconductor particles have sizes ranging up to about 100 microns. Preferably, the particles have sizes 90% of which range up to about about 15 microns or 90% of which range up to about about 10 microns. More preferably, 90% of the particles have particle sizes of about 1 to about 5 microns.

Preferably, the ratio of semiconductor particles to polymer binder in the particle content of the particle-in-binder composite layer is less than 70:30 by volume.

Preferably, the high-energy detection and imaging system further comprises an adhesive layer positioned between the conducting electrode layer and the particle-in-binder composite layer, for adherence of the particle-in-binder composite layer to the conducting electrode layer. Typically, the adhesive is a conducting adhesive.

Preferably, the particle-in-binder composite layer further comprises an adhesive layer in adhesive contact with an exposed surface of the particle-in-binder composite layer for adherence of the continuous multi-layer construction to a second substrate. Typically, this surface is the surface of the particle-in-binder composite layer that is distal from the conducting electrode layer. Preferably, the adhesive layer is a pressure sensitive adhesive layer, and the second substrate is a pixilated substrate.

Typically, the polymer substrate of the continuous multilayer construction from which the element of the system is constructed is a web-like or sheet-like substrate.

### BRIEF DESCRIPTION OF THE DRAWINGS

For a better understanding of the invention and to show how the same may be carried into effect, reference will now be made, purely by way of example, to the accompanying drawings.

With specific reference to the drawings, it is stressed that the particulars shown are by way of example and for purposes of illustrative discussion of the preferred embodiments of the present invention only. They are presented to provide what is believed to be the most useful and readily understood description of the principles and conceptual aspects of the invention. In this regard, no attempt is made to show structural details of the invention in greater detail than is necessary for a fundamental understanding of the invention, the description taken with the drawings making apparent to those skilled in the art how the several forms of the invention may be embodied in practice. In the accompanying drawings:

FIG. 1 is a schematic cross-sectional view of a continuous multi-layer construction constructed in accordance with a first embodiment of the present invention;

FIG. 2 is a schematic diagram showing a manufacturing rig suitable for applying various layers to a thick, metal-coated continuous polymer layer;

FIG. 3 is a flow diagram showing the stages of a manufacturing process for large area multi-layer polymer based high-energy electromagnetic radiation detecting and imaging devices;

FIG. 4 is a schematic cross-sectional view of a multi-layer planar structure constructed in accordance with an embodiment of the present invention;

FIG. 5 is a flow diagram showing the steps of a process by which the multi-layer structure shown in FIG. 4 may be fabricated;

FIG. 6 is a schematic cross-sectional view of a prototype structure constructed in accordance with an embodiment of the present invention;

FIG. 7 is a graph showing the sensitivity vs. applied bias response of the prototype shown in FIG. 6;

FIG. 8 is a graph showing the dark current vs. applied bias response of the prototype shown in FIG. 6; and

FIG. 9 is a graph showing the sensitivity to dark current ratio vs. applied bias response of the prototype shown in FIG. 6.

### DESCRIPTION OF THE PREFERRED EMBODIMENTS

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

It is appreciated that certain features of the invention, which are, for clarity, described in the context of separate embodiments, may also be provided in combination in a single embodiment. Conversely, various features of the invention that are, for brevity, described in the context of a single embodiment, may also be provided separately or in any suitable sub-combination.

Additionally, in what is described herein, whenever the terms “metallized” or “metal coated” substrates or films are used, the terms include electrically conductive materials in addition to metals, such as, but without being limiting, indium-tin oxide (ITO) and conductive polymers.

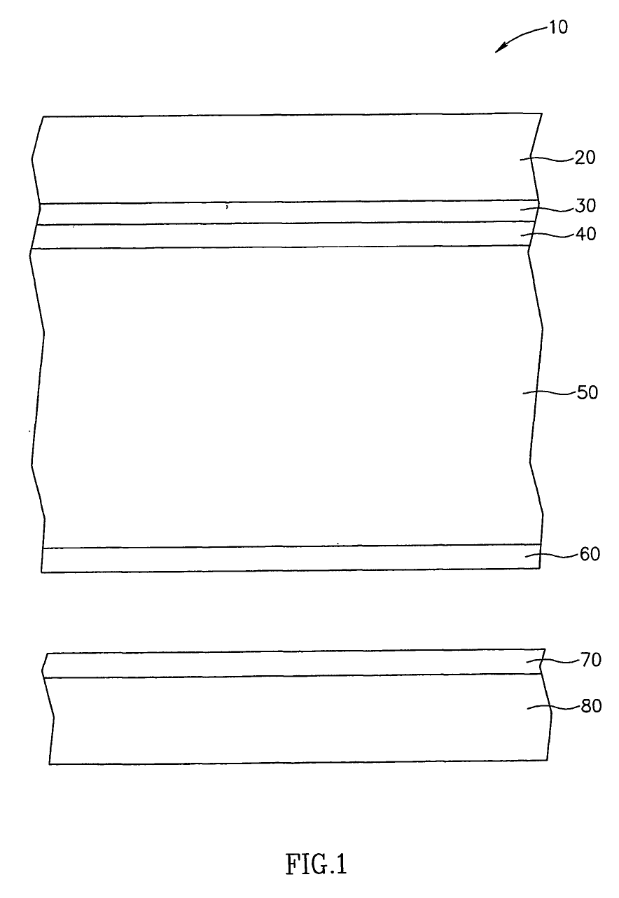

Reference is now made to FIG. 1, which shows a schematic cross-sectional view of a continuous multi-layer construction 10 constructed in accordance with a first embodiment of the present invention. Construction 10 comprises, in sequence, from top to bottom, a thick layer of a polymer sheet 20, such as a 200-micron thick polyethylene terephthalate (PET) sheet, coated with a conducting electrode layer 30, such as a 1 micron thick layer of indium-tin oxide, a thin conducting adhesive layer 40, such as Humiseal® 1B12, a commercially available polyacrylic, polyvinylic mixture in a mixed methyl ethyl ketone/toluene solvent, with the addition of a carbon black dispersion therein, and a composite wide band gap semiconductor layer 50, having a desired thickness, usually between about 200 micron and about 400 micron, which may be a particle-in-binder (PIB) layer of mercuric iodide (HgI₂) particles in a polystyrene binder, for example, and a thin, essentially non-conducting adhesive layer 60. The continuous multi-layer construction 10 is laminated with a removable backing 80 made of paper, for example, coated with a release 70, such as a silicon-based release.

The continuous multi-layer construction 10 may be cut into conveniently sized plates by a cutter, and after removal of the release 70 coated backing 80, adhered to a pixilated substrate such as a TFT array on amorphous silicon. Such TFTs are commercially available from dpiX LLC, Palo Alto, Calif.

Polyethylene terephthalate (PET) sheets pre-coated with an indium-tin oxide (ITO) layer are commercially available from Delta Technologies, Stillwater, Minn. and CP Films Inc., Martinsville, Va., for example. PET is fairly rigid and commercially available at thicknesses ranging from about 100 to about 2000 microns. It can be pre-coated with a mercuric iodide compatible conducting layer that is suitable for use as an electrode. It is a convenient, conducting electrode coated 30 polymer sheet that may be used as a pre-electroded polymer substrate 20 for the deposition of a composite wide band gap semiconductor layer 50 there upon. The thickness of the ITO coating may vary from about 0.2 microns to about 2 microns, and is used as a means for controlling the resistance of the layer. It will be appreciated, that a very wide range of aliphatic and aromatic homopolymers and copolymers are available as continuous films. These vary in thickness and flexibility and have various surface finishes. Many aliphatic and aromatic homopolymer and copolymer continuous films may be coated with conducting layers using sputtering or PVD for example, and then used as electrodes, and indeed, such metallized polymer films are commercially available. Particularly preferred alternatives are polycarbonate and cellulose acetate films.

ITO is a preferred electrode material for use when the electrode is in contact or close proximity with HgI₂, since HgI₂ is rather corrosive. There are many noble metals and other materials which do not react with HgI₂ and which may be used as an electrode coating 30 instead of ITO. These include, but are not limited to, Ni, Pt, Au, Pd, Cr, Ge, Si or C. In all cases, resistance control may be obtained by careful control of the electrode coating thickness. With other, less reactive wide band gap semiconductors such as PbI₂, other, less exotic, metals may be used as materials for electrode coating 30. A suspension of electrode material may be painted on. Alternatively, electrodes may be sputtered on, vacuum deposited, sprayed on, or screen-printed, for example. For ease of fabrication of continuous multi-layer construction 10, it is preferable to use metallized polymeric sheet materials having appropriate dimensions and chemical behaviour, when commercially available.

Thin conducting adhesive layer 40 should preferably be chemically compatible with both electrode coating 30 and with composite wide band gap semiconductor layer 50, to which it must adhere. Conducting adhesive layer 40 is preferably as thin as is practicable to manufacture. There are many commercially available adhesives that are compatible with electrode coating 30 and composite wide band gap semiconductor layer 50 materials. Such adhesives are commercially available from SPI Supplies, West Chester, Pa., Adhesive Research Inc., Glen Rock, Pa. or 3M, Minneappolis, Minn. Conducting adhesives generally include a fine dispersion of conducting particles in an adhesive polymer. When PIB composite wide band gap semiconductor layer 50 contains HgI₂ particles, the fine dispersion of conducting particles in adhesive polymer preferably does not react with HgI₂. Conductive carbon black is suitable as a fine dispersion for use in conducting adhesives for use with HgI₂.

A particle-in-binder composite material comprising mercuric iodide (HgI₂) particles in a polystyrene binder has been found to be suitable for the fabrication of composite wide band gap semiconductor layer 50. The addition of large quantities of methyl-benzene (toluene) produces a readily processable colloidal dispersion. Mercuric iodide has very good X-ray detecting properties, and polystyrene is a well-understood polymeric binder material, that allows for easy fabrication. Polystyrene may be dissolved in methyl benzene (toluene) and, by varying the average molecular weight of the polymer molecules, the quantity of solvent and other additives, the particle to binder ratio and the particle size, both the mechanical and photo-detecting properties of the dry film, and the surface tension, viscosity, rheology and density of the colloidal dispersion may be tailored for ease of fabrication and the desired properties of the product.

Nevertheless, alternative wide band gap semiconducting materials may be used instead of, or in addition to, HgI₂. Suitable alternative wide band gap semiconducting materials include lead iodide (PbI₂), bismuth iodide (BiI₃), thallium bromide (TlBr), cadmium telluride (CdTe), cadmium zinc telluride (CdZnTe) and mixtures thereof, for example.

In general, the composite wide band gap semiconductor layer 50 may contain up to 70% semiconductor particles by volume. Typically, such composite wide band gap semiconductor layers 50 comprise 60% semiconductor particles by volume. The wide band gap semiconductor particle size for preparing composite detectors are particles having grain sizes up to about 100 microns, more preferably having grain sizes 90% of which are up to about 15 microns, or having grain sizes 90% of which are up to about 10 microns. More preferably 90% of the particles have particle sizes of about 1 to about 5 microns.

There are a wide variety of candidate materials for the thin non-conducting adhesive layer 60. The thin non-conducting adhesive layer 60, typically a pressure sensitive adhesive, is required to be non-conducting in preferred embodiments. Its purpose is to allow for the adhesion of continuous multi-layer construction 10 to a pixilated substrate, such as a TFT array on amorphous silicon substrate, and a conducting adhesive will short the pixels. The thin, non-conducting adhesive layer 60 may comprise a semiconducting material such as a dispersion of semiconducting particles which may lower the dark current response of the resultant continuous multi-layer construction 10 on pixilated substrate, thereby improving the signal to noise ratio of the multi-layer detector plates thus formed. When the wide band gap semiconducting material of composite wide band gap semiconductor layer 50 comprises a material such as HgI₂, which may react with aluminum bus lines on the pixilated substrate, the thin non conducting adhesive layer 60 also may act as a protective barrier layer preventing such reactions.

The thin non-conducting adhesive layer 60 is laminated with a release 70 coated backing 80 layer, such as silicon-based release coated paper, for example. The choice of material for release 70 and backing 80 depends on the material selected for thin non-conducting adhesive layer 60. Indeed, all materials used for continuous multi-layer construction 10 are required to be mutually compatible with neighbouring materials, and having disclosed the requirements for the various layers, many alternative combinations will now suggest themselves to one skilled in the art.

The continuous multi-layer construction 10 is intended to be adhered to a pixilated substrate such as a pixel readout flat panel (FP) of TFT electronic components, a charge coupled device (CCD) or a complementary metal oxide semiconductor (CMOS) array, for example. Such pixel arrays are commercially available, and come printed onto suitable substrates such as amorphous silicon, glasses and polymeric materials. Typical FP and CCD substrates that may be used with continuous multi-layer construction 10 of FIG. 1 contain square pixels having a conductive coating, the latter serving as the bottom pixel electrodes for the detector. The pixels are typically about 100×100 microns and each pixel is separated from its nearest neighbours in all directions by about 10-15 microns.

After adhesion to a suitable pixilated substrate, the continuous multi-layer construction 10 may be encapsulated with Parylene, Humiseal® 1B12, or some such insulating, inert material and connected to a pixel array readout unit and incorporated within a high-energy detection and imaging system. The readout electronics unit may be connected to a PC, and the images acquired may then be evaluated with image viewing and acquisition software.

The thin conducting adhesive layer 40 may be applied to the conducting electrode layer 30 coated, thick polymer substrate 20 by using any standard liquid film coater, such as a slot-coater. Alternatively, a conducting, double-sided adhesive film may be used instead.

Likewise, the particle-in-binder (PIB) composite wide band gap semiconductor layer 50 may be coated onto the conducting adhesive layer 40 by use of any standard liquid film coater, such as a slot-coater. Where particularly thick particle-in-binder (PIB) composite wide band gap semiconductor layers 50 are required, the coated thick polymer substrate 20 may be passed through a liquid film coater several times to build up the coating, allowing the coating to dry when necessary.

The thick polymer substrate 20 coated with conducting electrode layer 30, conducting adhesive layer 40, and particle-in-binder (PIB) composite wide band gap semiconductor layer 50 may be coated with a non-conducting adhesive layer 60, which is preferably a pressure sensitive adhesive, using a liquid film coater and may be coated with a layer of release 70, such as a silicon-based release, using a liquid film coater.

The non-conducting adhesive layer 60, release 70 and backing 80 may also comprise a double-sided adhesive film with backing, in which case these layers may be laminated on in one step.

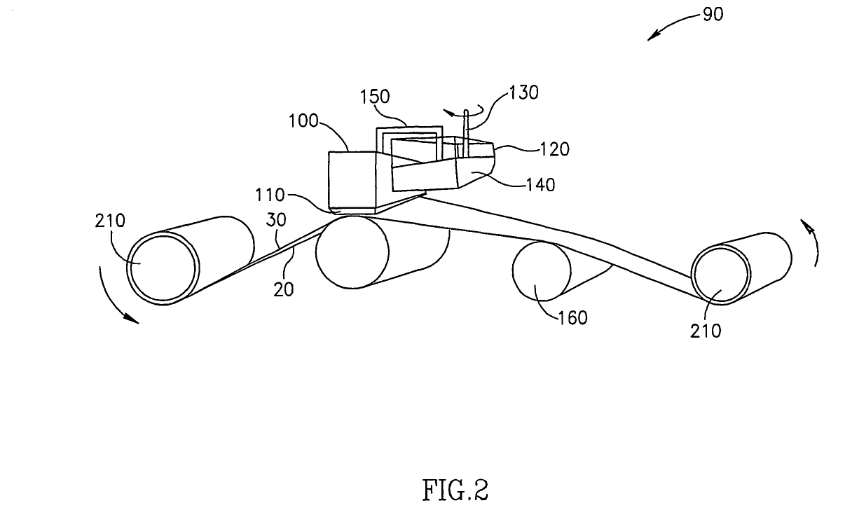

Reference is now made to FIG. 2, which is a schematic diagram illustrating a manufacturing rig 90 suitable for applying various layers to a metal coated 30, thick, continuous polymer substrate 20. Rig 90 includes a liquid film coater 100, dryer 160 and conveying means 210, which typically comprises rollers and the like. The liquid film coater 100 comprises an applicator 110, and a solution delivery system comprising a feeder tank 120 with stirrer 130, containing coating material 140, and conduits 150 for transporting coating material 140 from feeder tank 120 to applicator 110.

Coating material 140, such as feedstock adhesives and particle-in-binder slurries, are added to feeder tank 120 and may be stirred using stirrer 130. The coating material 140 may be conveyed to the applicator 110 via conduits 150. The conveying means 210 moves the thick polymer substrate 20, and any layers thereon, past applicator 110, which applies a coating of coating material 140. The thickness of the coating layer deposited onto the thick polymer substrate 20, and any layers thereon, is a function of measurable and controllable parameters. Such parameters include the speed at which the thick polymer substrate 20 passes the applicator 110, the rheology of the coating material 140, which itself is a function of molecular weight, solvent content, temperature etc., the dimensions of the applicator 110, the distance above the metal coating 30 on thick polymer substrate 20, and any subsequent layers thereon, at which the applicator 110 is set, and other parameters well-known and understood by one skilled in the art of liquid film coating. Because there are so many degrees of freedom, it is easy to vary the control parameters to achieve the desired results. The manufacturing rig 90 may be used for applying the thin conducting adhesive layer 40, the particle-in-binder (PIB) composite wide band gap semiconductor layer 50, the non-conducting adhesive layer 60 and the release layer 70 of continuous multi-layer construction 10 to the metal coated 30 thick polymer substrate 20, shown in FIG. 1.

There are a variety of widely available liquid film coater types suitable for applying the conducting adhesive layer 40, the particle-in-binder (PIB) composite wide band gap semiconductor layer 50, the non-conducting adhesive layer 60 and the release layer 70 of continuous multilayer construction 10, shown in FIG. 1. Thus, the liquid film coater 100 of FIG. 2 may be a flat die coater, a Mayer rod coater, a doctor blade system, a slot coater, a roller coater, a gravure coater, a bar coater, an air-jet coater or any other coating equipment capable of consistently applying coatings of the desired dimensions from the desired material onto a polymer substrate in the form of a single sheet or continuous web, with drying of each layer if necessary.

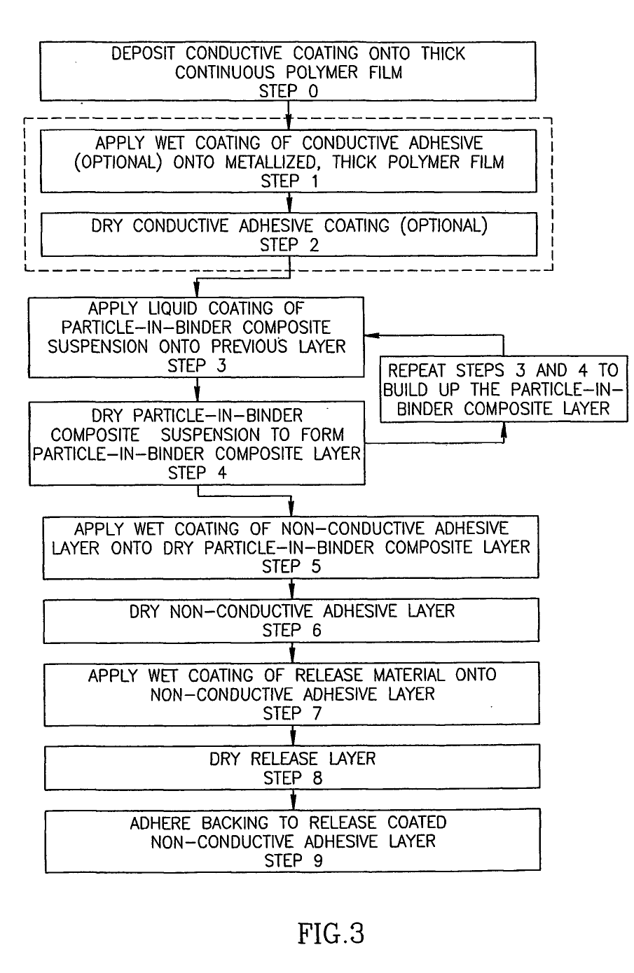

Reference is now made to FIG. 3, in which a flow diagram is presented which shows the manufacturing process for large area multi-layer polymer based high-energy electromagnetic radiation detecting and imaging devices. The manufacturing process for large area multi-layer polymer based high-energy electromagnetic radiation detecting and imaging devices comprises the following steps:

STEP 0—deposit a conductive coating onto a thick continuous polymer film. This may be achieved using PVD, sputtering, spraying, painting or any of a wide range of common metallizing processes. In preferred embodiments, pre-coated thick continuous polymer films can be purchased directly from a supplier and this step may be omitted;

STEP 1—apply a wet coating of conductive adhesive onto a metallized, thick polymer film using a liquid film coater (optional);

STEP 2—dry conductive adhesive coating (optional);

STEP 3—apply liquid coating of particle-in-binder composite suspension onto dried conductive adhesive layer (or directly onto the metallized, thick polymer film) using a liquid film coater;

STEP 4—dry the particle-in-binder composite suspension to form a particle-in-binder composite layer;

Steps 3 and 4 may be repeated to build up the particle-in-binder composite layer when particularly thick layers are required.

STEP 5—apply wet coating of non-conductive adhesive onto dry particle-in-binder composite layer using a liquid film coater;

STEP 6—dry the non-conductive adhesive layer;

STEP 7—apply a wet coating of release material onto the non-conductive adhesive layer using a liquid film coater;

STEP 8—dry the release layer; and

STEP 9—adhere backing to release coated non-conductive adhesive layer.

Alternatively, steps 7 to 9 may be combined, when a release coated backing, such as silicon-based resin coated paper, is applied in a single step.

Adhesive layers may, instead of being applied as wet layers, alternatively be laminated on as double-sided, self-adhesive films having the desired electrical properties. If this method is used, adhesive layer 60, release 70 and backing 80 may all be applied by lamination in a single laminating step.

It has been found that inclusion of an adhesive layer 40 between metal coated 30 thick polymer substrate 20 and PIB composite wide band gap semiconductor layer 50 aids adhesion of the metal coated 30 thick polymer substrate 20 to the PIB composite wide band gap semiconductor layer 50. However, it will be appreciated that, for certain combinations of metal (or conductive material) coated 30 thick polymer substrate 20 and for the binder of PIB composite wide band gap semiconductor layer 50, the inclusion of an adhesive layer 40 is not required. This is the case when the polymer binder of PIB composite wide band gap semiconductor layer 50 comprises certain acrylics, for example, and the conductive layer 30 comprises ITO. Thus, the inclusion of an adhesive layer 40 shown in FIG. 1 and corresponding steps 1 and 2 shown in FIG. 3 are not essential for the carrying out of the present invention.

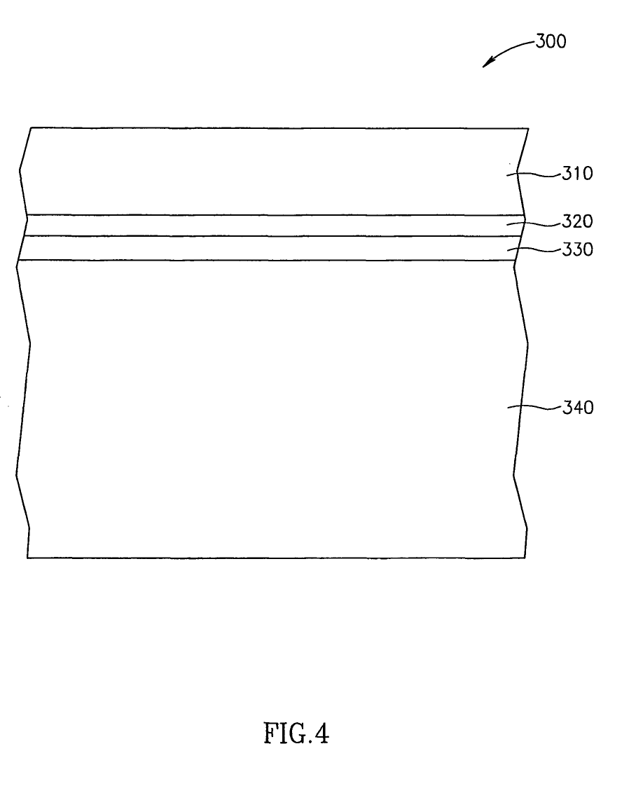

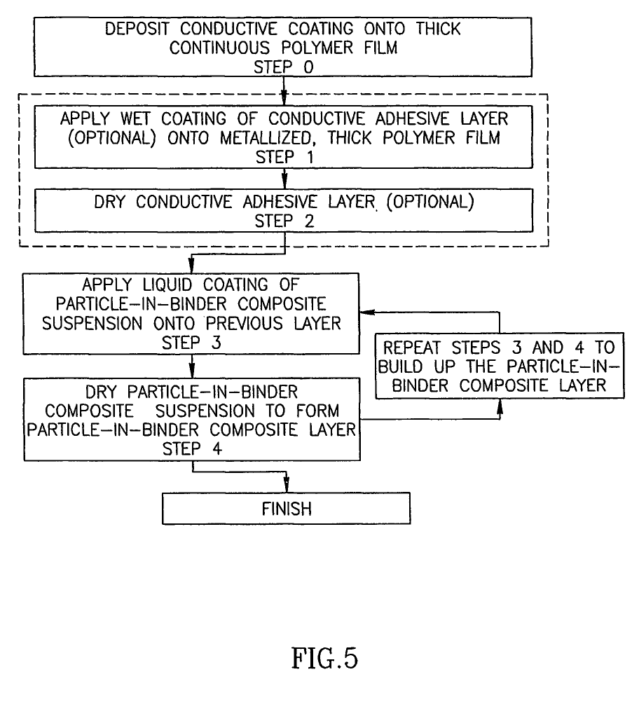

Reference is now made to FIG. 4, which shows a multi-layer planar structure 300 comprising a relatively thick polymer layer 310, a thin conducting layer 320, an optional adhesive layer 330, and a thick particle-in-binder composite layer 340 in that order, from top to bottom, and with further reference to FIG. 5, which shows the steps of a process by which such multi-layer structures may be fabricated. FIG. 5 includes the steps of:

STEP 0—deposit a conductive coating onto a thick continuous polymer film. This may be achieved using PVD, sputtering, spraying, painting or any of a wide range of common metallizing processes. In preferred embodiments, pre-coated thick continuous polymer films can be purchased directly from a supplier, and this step may be omitted;

STEP 1—apply a wet coating of a conductive adhesive layer onto the metallized, thick polymer film using a liquid film coater (optional);

STEP 2—dry the conductive adhesive layer (optional);

STEP 3—apply liquid coating of particle-in-binder composite suspension onto dried conductive adhesive layer (or directly onto metallized, thick polymer film) using a liquid film coater; and

STEP 4—dry the particle-in-binder composite suspension to form a particle-in-binder composite layer.

Steps 3 and 4 may be repeated to build up the particle-in-binder composite layer if particularly thick layers are required.

The present invention discloses liquid coating continuous films of particle-in-binder (PIB) composite materials comprising semiconductor particles and polymer binders, onto continuous metallized polymer substrates. It further discloses a multi-layer planar structure 300 comprising a relatively thick polymer layer 310 coated with a continuous conducting layer 320, the continuous conducting layer 320 in turn being coated with a particle-in-binder (PIB) composite layer 340, optionally, via an intermediate, conductive adhesive layer 330. PIB composite layer 340 comprises semiconductor particles in a polymeric binder.

### EXAMPLE

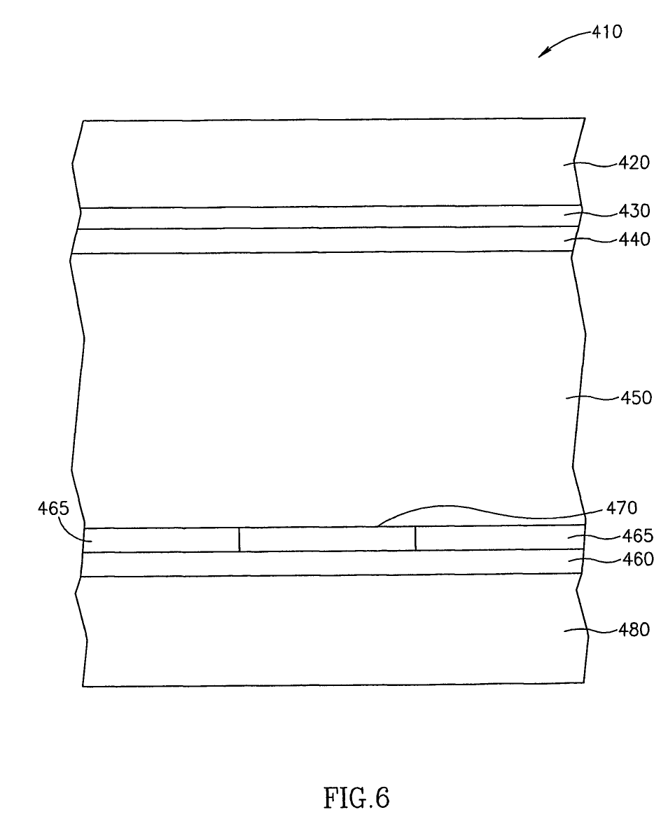

Referring now to FIG. 6, a cross-sectional schematic of a multi-layer prototype structure 410 is shown. As shown in FIG. 6, a multi-layer prototype structure 410 comprising a commercially available PET film 420 coated with an ITO layer 430 was adhered to a 200 micron thick HgI₂ and polystyrene composite layer 450, using a 160 micron thick double sided adhesive film 440 available from SPI Supplies, West Chester, Pa., Adhesive Research Inc., Glen Rock, Pa. or 3M, Minneappolis, Minn., among others. The multi-layer structure was adhered to an ITO 460 glass substrate 480 using one 1 cm×1 cm ‘pixel’ of double-sided conductive film 470. Areas 465 represent voids between ITO 460 glass substrate 480 and HgI₂ and polystyrene composite layer 450.

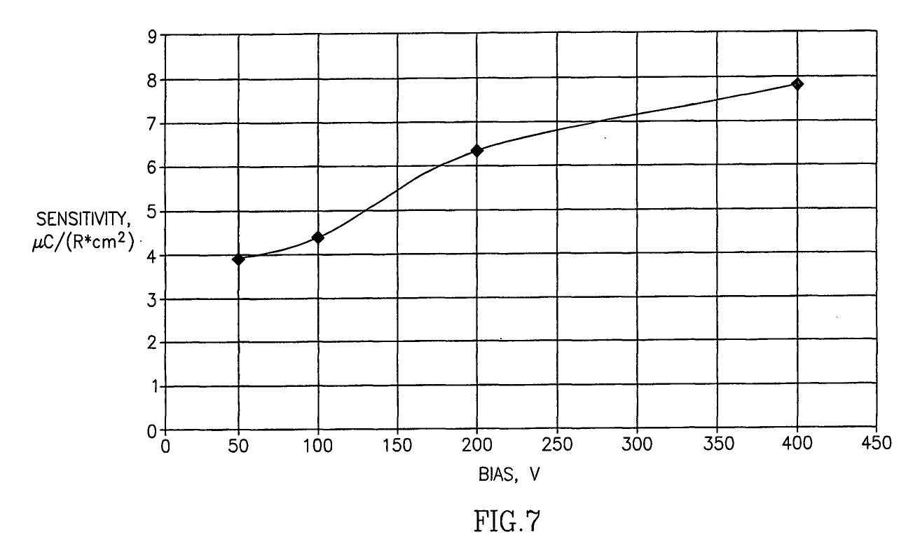

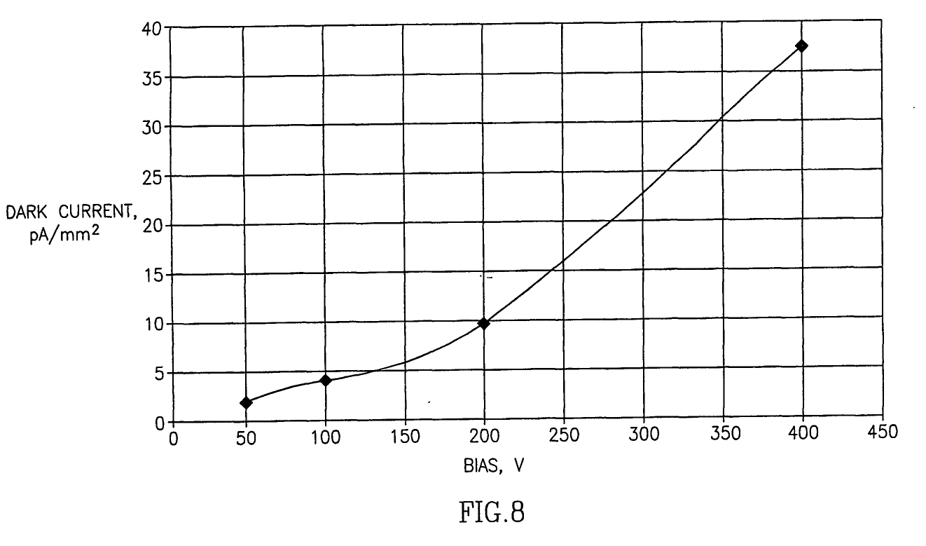

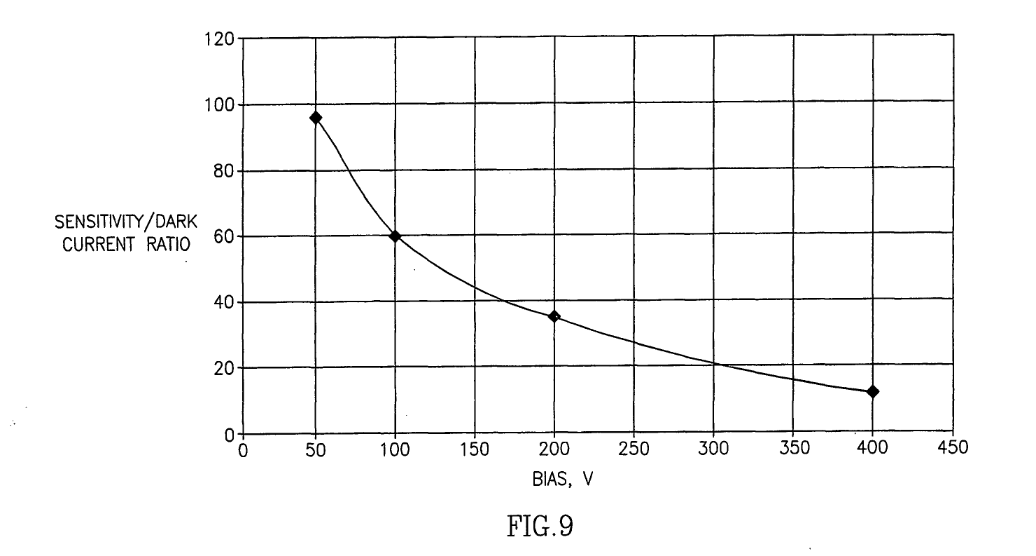

FIGS. 7, 8 and 9 are graphs showing the sensitivity, dark current and sensitivity to dark current ratio responses, respectively, with respect to applied bias for the prototype in FIG. 6. The results obtained demonstrate the feasibility of the multi-layer structures described hereinabove.

By constructing continuous multi-layer planar structures for applying to pixilated substrates to form detector and imager devices, whereby the multi-layer planar structures may be subjected to rigorous inspection before they are applied to the pixilated substrates, significant savings may result. Furthermore, the procedure produces cost saving by reducing the number of improperly fabricated pixelated substrates.

The polymer backed, continuous multi-layer planar structures and detector and imager devices fabricated therefrom, feature many handling and manufacturing advantages over the prior art.

It will be appreciated by persons skilled in the art that the present invention is not limited to what has been particularly shown and described hereinabove. Rather the scope of the present invention is defined by the appended claims and includes both combinations and sub-combinations of the various features described hereinabove as well as variations and modifications thereof, which would occur to persons skilled in the art upon reading the foregoing description.

The word comprise and variations thereof, such as comprising, comprised and the like, as used in the following claims implies that the subject matter specified comprises at least the elements, components or steps listed, and should not be construed to imply that the subject matter specified is limited to those elements, components or steps listed, to the exclusion of additional elements, components or steps.

1. A continuous multi-layer construction for detecting radiation comprising the following layers:
a polymer substrate;
a conducting electrode layer affixed to said polymer substrate; and
a particle-in-binder composite layer affixed to said conducting electrode layer, wherein said particle-in-binder composite layer absorbs photons, resulting in the ejection of electrons allowing for the detection of radiation.

2. A continuous multi-layer construction according to claim 1, further comprising a conductive adhesive layer, positioned between said conducting electrode layer and said particle-in-binder layer, for adhering said particle-in-binder layer to said conducting electrode layer.

3. A continuous multi-layer construction according to claim 1, further comprising an adhesive layer in adhesive contact with a side of said particle-in-binder layer distal from said conducting electrode layer, said adhesive layer for adhering said continuous multi-layer construction to a second substrate.

4. A continuous multi-layer construction according to claim 3, wherein said adhesive layer is a pressure sensitive adhesive layer.

5. A continuous multi-layer construction according to claim 3, wherein said second substrate is a pixilated substrate.

6. A continuous multi-layer construction according to claim 5, wherein said pixilated substrate is selected from the group consisting of a flat panel (FP) thin film transistor (TFT) array, a complementary metal oxide semiconductor (CMOS), and a charged coupled device (CCD).

7. A continuous multi-layer construction according to claim 1, wherein said polymer substrate comprises a polymer selected from the group consisting of aliphatic and aromatic homopolymers and copolymers.

8. A continuous multi-layer construction according to claim 1, wherein said particle-in-binder composite layer comprises wide band gap semiconductor particles embedded in a polymer binder.

9. A continuous multi-layer construction according to claim 8, wherein said particle-in-binder composite layer is characterized by at least one of the following features:
(a) said wide band gap semiconductor particles are particles of materials selected from the group of semiconductor materials consisting of lead iodide (PbI₂), bismuth iodide (BiI₃), thallium bromide (TlBr), mercuric iodide (HgI₂) cadmium telluride (CdTe), cadmium zinc telluride (CdZnTe) and mixtures thereof;
(b) said polymer binder includes at least one polymer selected from the group consisting of aliphatic and aromatic homopolymers and copolymers;
(c) said wide band gap semiconductor particles range in size up to 100 microns;
(d) said particle-in-binder composite layer has a ratio of semiconductor particles to polymer binder of less than 70:30 by volume.

10. A continuous multi-layer construction according to claim 9, wherein said wide band gap semiconductor particles have particle sizes 90% of which are up to 15 microns.

11. A continuous multi-layer construction according to claim 9, wherein said wide band gap semiconductor particles have particle sizes 90% of which are up to 10 microns.

12. A continuous multi-layer construction according to claim 9, wherein 90% of said wide band gap semiconductor particles are in the size range of from about 1 to about 5 microns.

13. A continuous multi-layer construction according to claim 8, further comprising an adhesive layer in adhesive contact with a side of said particle-in-binder layer distal from said conducting electrode layer, said adhesive layer for adhering said continuous multi-layer construction to a second substrate.

14. A continuous multi-layer construction according to claim 13, wherein said adhesive layer is a pressure sensitive adhesive layer.

15. A continuous multi-layer construction according to claim 13, wherein said second substrate is a pixilated substrate.

16. A continuous multi-layer construction according to claim 15, wherein said pixilated substrate is selected from the group consisting of a flat panel (FP) thin film transistor (TFT) array, a complementary metal oxide semiconductor (CMOS), and a charged coupled device (CCD).

17. A continuous multi-layer construction according to claim 1, wherein said polymer substrate is a web-like substrate.

18. A continuous multi-layer construction according to claim 1, wherein said polymer substrate is a sheet-like substrate.

19. A process for fabricating a continuous multi-layer construction for detecting radiation, said process comprising the following steps:
depositing a conducting electrode layer onto a continuous polymer film;
applying at least one coating layer of a particle-in-binder composite dispersion onto the conducting electrode layer; and
drying the at least one coating layer of the particle-in-binder composite dispersion.

20. A process according to claim 19, further comprising the step of applying an adhesive layer to an exposed surface of the particle-in-binder composite coating layer.

21. A process according to claim 20, further comprising adhering a release back coating to the adhesive layer.

22. A process according to claim 20, further comprising the steps of:
applying a release layer to the adhesive layer; and
laminating a backing onto the release layer.

23. A process according to claim 20, wherein the adhesive layer is a pressure sensitive adhesive layer.

24. A process according to claim 19, wherein said applying step is effected using a liquid film coater.

25. A process according to claim 19, further comprising the steps of:
applying a first adhesive layer; and
drying the first adhesive layer prior to said step of applying at least one coating layer of a particle-in-binder composite dispersion.

26. A process according to claim 25, wherein the first adhesive layer is a conductive adhesive layer.

27. A process according to claim 25, further comprising the step of applying a second adhesive layer to an exposed surface of the particle-in-binder composite coating layer.

28. A process according to claim 27, wherein the second adhesive layer is a pressure sensitive adhesive layer.

29. A process according to claim 27, further comprising adhering a release back coating to the second adhesive layer.

30. A process according to claim 27, further comprising the steps of:
applying a release layer to the second adhesive layer; and
laminating a backing onto the release layer.

31. A process according to claim 19, wherein said continuous polymer film is a sheet-like film.

32. A process according to claim 19, wherein said continuous polymer film is a web-like film.

33. A high-energy detection and imaging system comprising the following:
at least one element constructed from at least a part of a continuous multi-layer construction, wherein said construction comprises:
a polymer substrate;
a conducting electrode layer affixed to said polymer substrate; and
a particle-in-binder composite layer affixed to said conducting electrode layer; and
a second substrate, said second substrate affixed to said at least one element, wherein said particle-in-binder composite layer of said element absorbs photons, resulting in the ejection of electrons allowing for the detection of radiation.

34. A high-energy detection and imaging system according to claim 33, wherein said polymer substrate is a web-like substrate.

35. A high-energy detection and imaging system according to claim 33, wherein said polymer substrate is a sheet-like substrate.

36. A high-energy detection and imaging system according to claim 33, further comprising a conductive adhesive layer, positioned between said conducting electrode layer and said particle-in-binder layer, for adhering said particle-in-binder layer to said conducting electrode layer.

37. A high-energy detection and imaging system according to claim 33, further comprising an adhesive layer in adhesive contact with a side of said particle-in-binder layer distal from said conducting electrode layer, said adhesive layer for adhering said continuous multi-layer construction to said second substrate.

38. A high-energy detection and imaging system according to claim 37, wherein said adhesive layer is a pressure sensitive adhesive layer.

39. A high-energy detection and imaging system according to claim 37, wherein said second substrate is a pixilated substrate.

40. A high-energy detection and imaging system according to claim 39, wherein said pixilated substrate is selected from the group consisting of a flat panel (FP) thin film transistor (TFT) array, a complementary metal oxide semiconductor (CMOS), and a charged coupled device (CCD).

41. A high-energy detection and imaging system according to claim 33, wherein said polymer substrate is selected from a polymer from the group consisting of aliphatic and aromatic homopolymers and copolymers.

42. A high-energy detection and imaging system according to claim 33, wherein said particle-in-binder composite layer includes wide band gap semiconductor particles embedded in a polymer binder.

43. A high-energy detection and imaging system according to claim 42, characterized by at least one of the following features:
(a) said wide band gap semiconductor particles are particles of materials selected from the group of semiconductor materials consisting of lead iodide (Pb₂), bismuth iodide (BiI₃), thallium bromide (TlBr), mercuric iodide (HgI₂), cadmium telluride (CdTe), cadmium zinc telluride (CdZnTe) and mixtures thereof;
(b) said polymer binder includes at least one polymer selected from the group consisting of aliphatic and aromatic homopolymers and copolymers;
(c) said wide band gap semiconductor particles range in size up to 100 microns;
(d) said particle-in-binder composite layer has a ratio of semiconductor particles to polymer binder of less than 70:30 by volume.

44. A high-energy detection and imaging system according to claim 43, wherein said wide band gap semiconductor particles have particle sizes 90% of which are up to 15 microns.

45. A high-energy detection and imaging system according to claim 43, wherein said wide band gap semiconductor particles have particle sizes 90% of which are up to 10 microns.

46. A high-energy detection and imaging system according to claim 43, wherein 90% of said wide band gap semiconductor particles are in the size range of from about 1 to about 5 microns.

47. A high-energy detection and imaging system according to claim 42, further comprising an adhesive layer in adhesive contact with a side of said particle-in-binder layer distal from said conducting layer, said adhesive layer for adhering said continuous multi-layer construction to said second substrate.

48. A high-energy detection and imaging system according to claim 47, wherein said adhesive layer is a pressure sensitive adhesive layer.

49. A high-energy detection and imaging system according to claim 47, wherein said second substrate is a pixilated substrate.

50. A high-energy detection and imaging system according to claim 49, whereby said pixilated substrate is selected from the group consisting of a flat panel (FP) thin film transistor (TFT) array, a complementary metal oxide semiconductor (CMOS), and a charged coupled device (CCD).

51. A high-energy detection and imaging system constructed according to claim 33 and used as a high-energy radiation detection system.

52. A high-energy detection and imaging system constructed according to claim 33 and used as a high-energy radiation imaging system.
